(19) United States
(12) Patent Application Publication
(10) Pub. No.: US 2023/0030210 A1
(43) Pub. Date: Feb. 2, 2023

(54) TEA IMPURITY DATA ANNOTATION METHOD BASED ON SUPERVISED MACHINE LEARNING

(71) Applicant: Kunming University, Kunming City (CN)

(72) Inventors: Jun He, Kunming City (CN); Caiqing Zhang, Kunming City (CN); Fei Deng, Kunming City (CN); Jing Yu, Kunming City (CN); Ming Jing, Kunming City (CN)

(21) Appl. No.: 17/546,085

(22) Filed: Dec. 9, 2021

(30) Foreign Application Priority Data
Jul. 30, 2021 (CN) 2021108705405

(51) Int. Cl. G06N 5/04; G06N 20/00

(52) U.S. Cl. CPC G06N 5/04; G06N 20/00

(57) ABSTRACT

A tea impurity data annotation method based on supervised machine learning is provided. In particular, a feature vector of tea and impurity is first extracted by using a traditional image processing method, each element in the feature vector then is added with a corresponding annotation bit, a training dataset and a test dataset subsequently are divided by using a manual discrimination method, and afterwards data annotation is performed on each feature element in the test dataset. The manual method and the supervised machine learning method are combined, which can improve the accuracy and ensure the work efficiency.

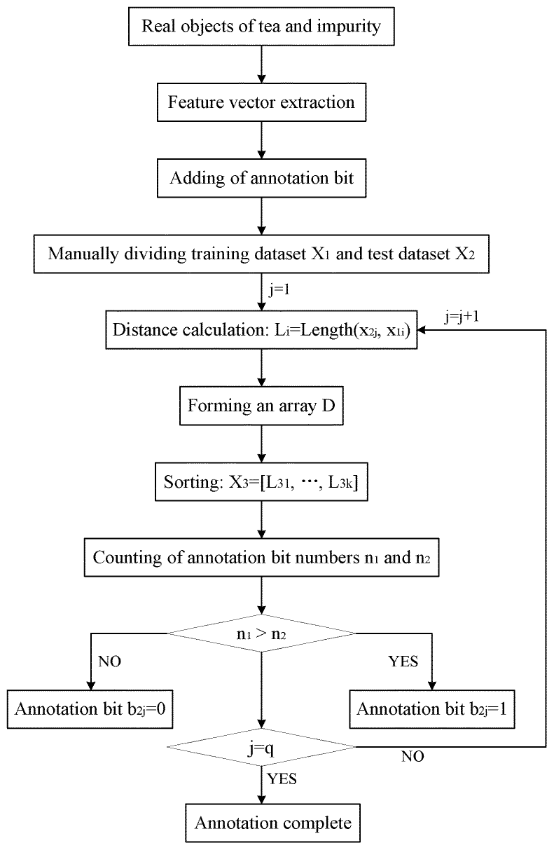

### TECHNICAL FIELD

The invention relates to the technical field of machine learning and image processing, and more particularly to a tea impurity data annotation method based on supervised machine learning.

### DESCRIPTION OF RELATED ART

In a process of tea processing, impurities are often mixed therein, and how to correctly recognize tea and remove impurities is a key process. At present, in a process of automatic recognition of tea and impurities by an image processing method, data annotation is often carried out according to image features, and traditional data annotation methods mainly rely on pure manual or random allocation. When the data annotation relies on pure manual, it is inefficient and labor cost is high. When the data annotation relies on random allocation, the accuracy of data annotation is not high, which would affect a final recognition effect. Aiming at the above problems, a tea impurity data annotation/labelling method based on supervised machine learning is proposed.

### SUMMARY

A technical problem to be solved by the invention is to provide a tea impurity data annotation method based on supervised machine learning, to solve the above-mentioned defects in the prior art.

In order to achieve the above objective, the invention illustratively proposes technical solutions as follows.

Specifically, a tea impurity data annotation method based supervised machine learning, may include:

step 1, extracting a feature vector of tea and impurity by using a traditional image processing method;

step 2, adding a corresponding annotation bit to each element in the feature vector to obtain a processed feature vector;

step 3, dividing the processed feature vector into a training dataset and a test dataset by using a manual discrimination method; and

step 4, performing data annotation on the test dataset by using the training dataset, in a supervised machine learning manner.

In a preferred embodiment, in the step 1, multiple (i.e., more than one) feature vectors including color, texture and shape are extracted, and the multiple feature vectors are combined into the feature vector X:

$$X = [ \begin{matrix}{x}_{11} & {x}_{12} & … & … & {x}_{1 n} \\ {x}_{21} & ⋱ & & & ⋮ \\ ⋮ & & {x}_{ij} & & ⋮ \\ ⋮ & & & ⋱ & ⋮ \\ {x}_{m 1} & … & … & … & {x}_{mn}\end{matrix} ]$$

where X is a multi-dimensional matrix of n*m, and n, m both are positive integers.

In a preferred embodiment, in the step 2, each the element xᵢⱼ in the feature vector X is added with the unique annotation bit bᵢⱼ, and thereby the feature vector X is transformed into the processed feature vector as follows:

$$X = [ \begin{matrix}( {x}_{11} , {b}_{11} ) & ( {x}_{12} , {b}_{12} ) & … & … & ( {x}_{1 n} , {b}_{1 n} ) \\ ( {x}_{21} , {b}_{21} ) & ⋱ & & & ⋮ \\ ⋮ & & ( {x}_{ij} , {b}_{ij} ) & & ⋮ \\ ⋮ & & & ⋱ & ⋮ \\ ( {x}_{m 1} , {b}_{m 1} ) & … & … & … & ( {x}_{mn} , {b}_{mn} )\end{matrix} ] .$$

In a preferred embodiment, the step 4 includes: for a to-be-annotated feature (element) in the test dataset, traversing all elements in the training dataset, calculating distances between the all elements and the to-be-annotated feature, and saving the distances in an array D; and

performing a sorting on the array D, taking K number of features with smallest distances into a dataset X₃, and counting the number of annotation bit of 1 and the number of annotation bit of 0 in the dataset X₃;

the sorting on the array D is to reduce calculation workload, k is an odd number to ensure that the number of annotation bit of 1 is not equal to the number of annotation bit of 0; and

a value of the annotation bit of the to-be-annotated feature is set as the value of the annotation bit having a counting number corresponding to the maximum one of the number of annotation bit of 1 and the number of annotation bit of 0 in the dataset X₃.

In a preferred embodiment, the step 4 specifically includes the following sub-steps:

sub-step (a), distance calculation, including: for a first to-be-annotated feature x₂ⱼ (j=1) in the test dataset X₂ having q number of features, traversing all features/elements x₁ᵢ (i=1, . . . , p) in the training dataset X₁, calculating distances Lᵢ between the features x₁ᵢ in the training dataset X₁ and the to-be-annotated feature x₂ⱼ as Lᵢ=Length(x₂ⱼ, x₁ᵢ), and saving the distances Lᵢ in an array D;

sub-step (b), sorting, including: performing a sorting on the array D, taking k number of features with nearest/smallest distances and recording as X₃=[L₃ₗ, . . . , L₃ₖ];

sub-step (c), counting of numbers of annotation bits, including: counting the number of annotation bit of 1 and the number of annotation bit of 0 in the X₃, and recording the number of features annotated with 1 in the X₃ as n₁ and the number of features annotated with 0 in the X₃ as n₂;

sub-step (d), annotating, including: setting (a value of) the annotation bit b₂ⱼ of the x₂ⱼ to be 1 when n₁>n₂, or setting the annotation bit b₂ⱼ of the x₂ⱼ to be 0 when n₁<n₂;

and so on, j=j+1, traversing all to-be-annotated features x₂ⱼ in the test dataset X₂ for the data annotation until j=q by repeating the above sub-steps (a)˜(d), thereby completing the data annotation to all features/elements in the test dataset X₂.

Beneficial effect of adopting the above technical solutions may be that: the invention may have high tolerance for abnormal value and noise, compared with the principle of randomly allocating training dataset and test dataset in the traditional k-nearest neighbor algorithm, the training dataset and test dataset of the invention are determined manually to ensure that the data annotation accuracy of the training dataset may reach 100%. Moreover, the combination of manual method and supervised machine learning method can improve the accuracy and ensure the work efficiency.

### BRIEF DESCRIPTION OF DRAWING

The FIGURE is a schematic flowchart according to the invention.

### DETAILED DESCRIPTION OF EMBODIMENTS

Preferred embodiments of the invention will be described below in detail with reference to the accompanying drawing.

Referring to the FIGURE, a tea impurity data annotation method based on supervised machine learning is provided. First, a traditional image processing method is used to extract a feature vector of tea and impurity; second, each of elements in the feature vector is added with a corresponding annotation bit; third, a test dataset and a training dataset are divided through a manual discrimination method; and fourth, data annotation is performed on each element in the test dataset. More detailed description will be given as follows.

Feature Vector Extraction:

For real objects of tea and impurity, the real objects are converted into an image by photographing, and then a RGB color image model, a median filtering method and image segmentation may be used to preprocess the image. Afterwards, a color histogram method, an edge direction histogram method and a Hu matrix method may be used to extract several feature vectors such as color, texture and shape. Finally, the several feature vectors are combined to obtain a final feature vector X.

$$X = [ \begin{matrix}{x}_{11} & {x}_{12} & … & … & {x}_{1 n} \\ {x}_{21} & ⋱ & & & ⋮ \\ ⋮ & & {x}_{ij} & & ⋮ \\ ⋮ & & & ⋱ & ⋮ \\ {x}_{m 1} & … & … & … & {x}_{mn}\end{matrix} ]$$

where X is a multi-dimensional matrix of n*m, n, m both are positive integers.

Adding of Annotation Bit:

For the feature vector X, each element xᵢⱼ in X is added with a annotation bit bᵢⱼ, and then the feature vector X is transformed to be that:

$$X = [ \begin{matrix}( {x}_{11} , {b}_{11} ) & ( {x}_{12} , {b}_{12} ) & … & … & ( {x}_{1 n} , {b}_{1 n} ) \\ ( {x}_{21} , {b}_{21} ) & ⋱ & & & ⋮ \\ ⋮ & & ( {x}_{ij} , {b}_{ij} ) & & ⋮ \\ ⋮ & & & ⋱ & ⋮ \\ ( {x}_{m 1} , {b}_{m 1} ) & … & … & … & ( {x}_{mn} , {b}_{mn} )\end{matrix} ] .$$

Dividing of Test Dataset and Training Dataset:

The manual discrimination method is adopted, a small area of the image of tea and impurity with most significant features is chosen, and annotation bits corresponding to its features each are annotated/labelled as 1 or 0 (where 1 denotes that the feature corresponds to the tea, while 0 denotes that the feature corresponds to the impurity) to form the training dataset X₁=[x₁₁, . . . , x₁ₚ], where the number of features in the training dataset X₁ is p. The training dataset X₁ is annotated by the manual discrimination method, which can ensure annotation accuracy of X₁ to reach 100%.

Afterwards, features corresponding to remaining large area of the image of tea and impurity are classified into the test dataset X₂=[x₂₁, . . . , x_{2q}], where the number of features in the test dataset X₂ is q.

The sum of the numbers of elements of the training dataset X₁ and the test dataset X₂ is p+q=n*m.

Performing of Data Annotation:

Distance calculation: for a first to-be-annotated feature x₂ⱼ (j=1), traversing all the features X₁ᵢ (i=1, . . . , p) in the training dataset X₁, calculating distances Lᵢ between all the features in the training dataset X₁ and the to-be-annotated feature as that Lᵢ=Length(x₂ⱼ, x₁ᵢ), and saving the distances Lᵢ in an array D.

Sorting: performing a sorting on the array D, taking K features with nearest/smallest distances (k is an odd number) and recording as X₃=[L₃ₗ, . . . , L₃ₖ].

Counting of numbers of annotation bits: Counting the number of annotation bit of 1 and the number of annotation bit of 0 in X₃ that is, the number of features annotated with 1 in X₃ is n₁, and the number of features annotated with 0 in X₃ is n₂.

Annotating: when n₁>n₂, the annotation bit b₂ⱼ of x₂ⱼ is set to be 1 (i.e., b₂ⱼ=1), whereas, when n₁<n₂, the annotation bit b₂ⱼ of x₂ⱼ is set to be 0 (i.e., b₂ⱼ=0).

and so forth, j=j+1, traversing all to-be-annotated features x₂ⱼ in the test dataset X₂ for data annotation, repeating the above steps of distance calculation, sorting, counting of numbers of annotation bits, and annotating until j=q, the data annotation for all features in the test dataset X₂ is finished consequently.

The invention will be further described in detail below, which is an interpretation of the invention rather than a limitation.

Step 1, extracting the feature vector X for real objects of tea and impurity.

Step 2, adding the annotation bit bᵢⱼ to each the element xᵢⱼ in the feature vector X.

Step 3, manually dividing the training dataset X₁ and the test dataset X₂ to ensure that annotation accuracy of the training dataset X₁ may reach 100%. More specifically, selecting a small area of the image of tea and impurity with the most noticeable features, and marking the annotation bits corresponding to its features as 1 or 0 respectively (1 denotes that the feature corresponds to tea, and 0 denotes that the feature corresponds to impurity) to form the training set X₁, and the features corresponding to the remaining large area of the image of tea and impurity are classified into the test dataset X₂.

Step 4, calculating the distances Lᵢ=Length(x₂ⱼ, x₁ᵢ) between the features in X₁ and the first to-be-annotated feature x₂ⱼ (j=1) in the test dataset X₂.

Step 5, saving the distances Lᵢ in the array D.

Step 6, performing a sorting on the array D and taking K features with smallest distances as X₃=[L₃ₗ, . . . , L₃ₖ].

Step 7, counting the number of annotation bit of 1 and the number of annotation bit of 0 in X₃, that is, the number of features annotated with 1 is n₁, and the number of features annotated with 0 in X₃ is n₂.

Step 8, when n₁>n₂, the annotation bit b₂ⱼ=1, whereas, when n₁<n₂, the annotation bit b₂ⱼ=0.

Step 9, when j<p, j=j+1, returning to the step 4 and repeating the step 4 through step 8, and when j=p, the data annotation ends.

The invention may have high tolerance for abnormal value and noise, compared with the principle of randomly assigning training dataset and test dataset in the traditional k-nearest neighbor algorithm, the training dataset and test dataset of the invention are determined manually to ensure that the data annotation accuracy of the training dataset may reach 100%. Moreover, the combination of manual method and supervised machine learning method can improve the accuracy and ensure the work efficiency.

The above description is only preferred embodiments of the invention. It should be noted that for those skilled in the art, various modifications and substitutions can be made without departing from the inventive concept, which belong to the protection scope of the invention.

What is claimed is:

1. A tea impurity data annotation method based on supervised machine learning, comprising:
step 1, extracting a feature vector of tea and impurity by using an image processing method;
step 2, adding a corresponding annotation bit to each of elements in the feature vector to obtain a processed feature vector;
step 3, dividing the processed feature vector into a training dataset and a test dataset by using a manual discrimination method; and
step 4, performing data annotation on the test dataset by using the training dataset, in a supervised machine learning manner.

2. The tea impurity data annotation method based on supervised machine learning as claimed in claim 1, wherein in the step 1, a plurality of feature vectors including color, texture and shape are extracted, and the plurality of feature vectors are combined into the feature vector X,
$$X = [ \begin{matrix}{x}_{11} & {x}_{12} & … & … & {x}_{1 n} \\ {x}_{21} & ⋱ & & & ⋮ \\ ⋮ & & {x}_{ij} & & ⋮ \\ ⋮ & & & ⋱ & ⋮ \\ {x}_{m 1} & … & … & … & {x}_{mn}\end{matrix} ]$$
where X is a multi-dimensional matrix of n*m, and n, m both are positive integers.

3. The tea impurity data annotation method based on supervised machine learning as claimed in claim 1, wherein in the step 2, each the element xᵢⱼ in the feature vector X is added with the annotation bit bᵢⱼ, and the feature vector X is transformed into the processed feature vector as that:
$$X = [ \begin{matrix}( {x}_{11} , {b}_{11} ) & ( {x}_{12} , {b}_{12} ) & … & … & ( {x}_{1 n} , {b}_{1 n} ) \\ ( {x}_{21} , {b}_{21} ) & ⋱ & & & ⋮ \\ ⋮ & & ( {x}_{ij} , {b}_{ij} ) & & ⋮ \\ ⋮ & & & ⋱ & ⋮ \\ ( {x}_{m 1} , {b}_{m 1} ) & … & … & … & ( {x}_{mn} , {b}_{mn} )\end{matrix} ] .$$

4. The tea impurity data annotation method based on supervised machine learning as claimed in claim 1, wherein the step 4 comprises:
for a to-be-annotated feature in the test dataset, traversing all elements in the training dataset, calculating distances between the all elements and the to-be-annotated feature, and saving the distances in an array D; and
performing a sorting on the array D, taking K number of features with smallest distances into a dataset X₃, and counting the number of annotation bit of 1 and the number of annotation bit of 0 in the dataset X₃;
wherein the sorting on the array D is to reduce calculation workload, k is an odd number to ensure that the number of annotation bit of 1 is not equal to the number of annotation bit of 0, and a value of annotation bit of the to-be-annotated feature is set as the value of the annotation bit having a counting number corresponding to the maximum one of the number of annotation bit of 1 and the number of annotation bit of 0 in the dataset X₃.

5. The tea impurity data annotation method based on supervised machine learning as claimed in claim 1, wherein the step 4 specifically comprises:
distance calculation, comprising: for a first to-be-annotated feature x₂ⱼ (j=1) in the test dataset X₂ having q number of features, traversing all features x₁ᵢ (i=1, . . . , p) in the training dataset X₁, calculating distances Lᵢ between the features x₁ᵢ in the training dataset X₁ and the to-be-annotated feature x₂ⱼ as Lᵢ=Length(x₂ⱼ, x₁ᵢ), and saving the distances Lᵢ in an array D;
sorting, comprising: performing a sorting on the array D, taking k number of features with smallest distances and recording as X₃=[L₃ₗ, . . . , L₃ₖ];
counting of numbers of annotation bits, comprising: counting the number of annotation bit of 1 and the number of annotation bit of 0 in the X₃, and recording the number of features annotated with 1 in the X₃ as n₁ and the number of features annotated with 0 in the X₃ as n₂;
annotating, comprising: setting the annotation bit b₂ⱼ of the x₂ⱼ to be 1 when n₁>n₂, or setting the annotation bit b₂ⱼ of the x₂ⱼ to be 0 when n₁<n₂; and
j=j+1, traversing all to-be-annotated features x₂ⱼ in the test dataset X₂ for the data annotation until j=q, thereby completing the data annotation for all features in the test dataset X₂.
